(19) United States
(12) Patent Application Publication
(10) Pub. No.: US 2025/0244234 A1
(43) Pub. Date: Jul. 31, 2025

(54) DEVICE FOR MEASURING ELEMENTAL AND MOLECULAR PROPERTIES WITH HYBRID ELECTROMAGNETIC WAVES

(71) Applicant: HAUS SPS MAKINA ELEKTRONIK BILISIM SANAYI VE TICARET ANONIM SIRKETI, Aydin (TR)

(72) Inventor: Ismail BOGREKCI, Aydin (TR)

(73) Assignee: HAUS SPS MAKINA ELEKTRONIK BILISIM SANAYI VE TICARET ANONIM SIRKETI, Aydin (TR)

(21) Appl. No.: 18/281,300

(22) PCT Filed: Oct. 19, 2022
(86) PCT No.: PCT/TR2022/051158

§ 371 Date: Sep. 10, 2023

(30) Foreign Application Priority Data
Sep. 16, 2022 (TR) 2022/014355

(51) Int. Cl. G01N 21/3504; G01N 21/33; G01N 22/00; G01N 23/00

(52) U.S. Cl. CPC G01N 21/3504; G01N 21/33; G01N 22/00; G01N 23/00; G01N 2201/0873; G01N 2223/045; G01N 2223/1013; G01N 2223/1016

(57) ABSTRACT

The present invention relates to an intelligent measuring system which is composed by integrating X-Rays, Gamma-Rays, ultraviolet rays, Visible light, near-mid-far infrared rays, and reflection and transmission methods with fiber cables, optical systems, and optical sensors to microwave and radio waves by using artificial intelligence and statistical methods. Particularly, the present comprises a hybrid optical measurement system that can be used in all areas to determine elements and molecules in solid, liquid, and gas phases, as well as specifically to determine the elements with the properties of moisture, protein, fat, and carbohydrate etc.

### TECHNICAL FIELD OF THE INVENTION

The present invention relates to an intelligent measuring system which is composed by integrating X-Rays, Gamma-Rays, ultraviolet rays, Visible light, near-mid-far infrared rays, and reflection and transmission methods with fiber cables, optical systems, and optical sensors integrated with microwave and radio waves by using artificial intelligence and statistical methods. Particularly, the present invention comprises a hybrid optical measurement system that can be used in all areas to determine elements and molecules in solid, liquid, and gas phases, as well as specifically to determine the properties of the elements, molecules, moisture, protein, fat, and carbohydrate etc.

### STATE OF THE ART

Optical sensors, optical systems, and radiation sources are created, designed, and manufactured in specific wavelength ranges in the implementations of the available systems. Therefore, they work in practice within these limited ranges. They require separate calibrations for each, which can be very costly and time consuming. In other words, in available systems, measurements of X-Rays, Gamma-Rays, UV (ultraviolet), Visible Region, and Near-Mid-Far Infrared rays are optically designed, manufactured, and used separately.

In available systems, sensors and devices from abroad are very costly and time-consuming to obtain. The systems consist of a single measurement method or, at most, the integration of three systems, as in UV-VIS-NIR systems. In these measurement systems, individual measurements are carried out for each wavelength, respectively. Only the measuring range has been extended.

Equivalent systems are produced as different and single radiation sources, optical systems, and sensors. These systems are calibrated according to the parameter to be measured for each product. Since these are calibrated to determine certain parameters, they are only used for the measurement of that parameter. The measuring ranges are therefore quite limited.

In the state of the art, the patent numbered “U.S. Pat. No. 10,948,434B2” relates to a X-ray spectroscopic analysis apparatus and elementary analysis method. The beams from the radiation apparatus are incident on the predetermined irradiation area on the surface of the sample. An analyzing crystal has been provided facing the irradiation area. A slit has been provided between the crystal and the irradiation area. The X-ray linear sensor was arranged in a direction perpendicular to the slit. Thus, more sensitive measurements are performed compared to conventional X-ray spectroscopy analysis methods.

The patent numbered “U.S. Pat. No. 6,521,894B1” in the state of the art comprises combining radiation detectors with a scintillator and semiconductor drift photodetector, and producing components by changing the geometry, size and position thereof. In photodetector pairs, it will be possible to achieve greater signal-to-noise ratio by matching the scintillator decay and drift times. An amplifier circuit has been included in the photodetectors to amplify the electrical signals.

The patent numbered “U.S. Pat. No. 9,018,592B2” in the state of the art relates to a device developed to perform ultraviolet spectroscopy analysis for determining gas components. Device consists of a measurement channel, a transparent window, and a spectrographic member. The gas flow channel and the measurement window are conveniently placed so that the measurement can be performed. The produced ultraviolet light is passed through the transparent window and flows into the gas flow channel, interacts with the accommodated gas, and is measured in the detector, and converted into an electrical signal.

The patent numbered “U.S. Pat. No. 6,559,941B1” in the state of the art comprises UV-VIS spectrophotometry. In the patent of which protection period has expired, the pulsed beam reaches the monochromator through a replaceable slit. The beam reaching the sample from the monochromator is re-emitted and converted into an electrical signal in the detector. Xenon lamp was used in this configuration. PMTs (photomultiplier tubes) that can measure between 190-1100 nm were used.

In the state of the art, the patent numbered “U.S. Pat. No. 8,368,892B2” refers to an apparatus that works with infrared spectroscopy. This device consists of a beam source that gives a beam of light, a beam splitter that allows the beam to pass over samples and references, and a prism and a detector that separates the beams according to their wavelengths. In addition, said device consists of a system and a microprocessor that enables wireless transmission of the signal obtained after the detector.

In the state of the art, the patent numbered “U.S. Pat. No. 8,368,892B2” refers to an apparatus that works with near-infrared reflection spectroscopy. Said device consists of a system that makes spectral measurements between 700-1100 nm or 900-1700 to identify solid and powdery materials. Multivariate calibration methods provide quantitative measurement.

In the state of the art, the patent numbered “U.S. Pat. No. 8,368,892B2” refers to a device that works with near infrared transmission spectroscopy. Said device consists of a system that makes spectral measurements between 700-1100 nm or 900-1700 to identify solid and solid materials. Multivariate calibration methods provide quantitative measurement.

Consequently, the fact that the approaches described above and so far receive information at certain wavelengths or in a certain band gap, and the inadequacy of available solutions in this regard necessitated making an improvement in the relevant technical field.

### BRIEF DESCRIPTION AND OBJECTS OF THE INVENTION

The most important object of the present invention is to develop an innovative system in the field of technological spectroscopy with both reflection and transmission modes by interacting X-ray, Gamma-ray, Ultraviolet, Visible Region, and Infrared lights with microwave and radio waves.

Another object of the present invention is to provide an accurate and sensitive measurement.

Yet another object of the present invention is to develop a system that provides high accuracy analysis by using statistical and artificial intelligence methods.

Yet another object of the present invention is to develop a system that can measure in a wide electromagnetic spectrum and has a signal processing property.

Yet another object of the present invention is to develop a digital signal processing system that will improve the signals with spectral signal processing methods.

Yet another object of the present invention is to develop a system that can optically provide both reflection and transmission properties.

Yet another object of the present invention is to develop an optical system to make the molecules in the sample vibrate by creating electromagnetic waves in different combinations.

Yet another object of the present invention is to develop an optical system to make the elements in the sample vibrate by creating electromagnetic waves in different combinations.

Yet another object of the present invention is to develop an optical matrix that enables forming the appropriate electromagnetic beam/wave combination according to the molecule/element required to be determined.

Yet another object of the present invention is to develop optical systems capable of forming combinations of certain beam spacings and points in beams formed in different combinations.

Yet another object of the present invention is to develop optical systems capable of forming combinations of specific beam spacings and points in beams formed by the integration of different wavelengths with each other.

Yet another object of the present invention is to develop optical systems capable of forming combinations of specific beam spacings and points by acting on beams of different wavelengths with triggering/interfering waves.

Yet another object of the present invention is to develop an optical system to increase vibrations with hybrid beams at certain beam intervals and points, and to perform detection by interacting elements/molecules that need to be detected with beams of different wavelengths with triggering/interfering waves.

Structural and characteristic features of the present invention as well as all advantages thereof will become clear through the attached figures and the following detailed description provided by making references thereto. Therefore, the assessment should be made by taking these figures and the detailed description into consideration.

### DESCRIPTION OF THE FIGURES

FIG. 1 is the drawing that illustrates the view of beam/light sources in the system according to the present invention.

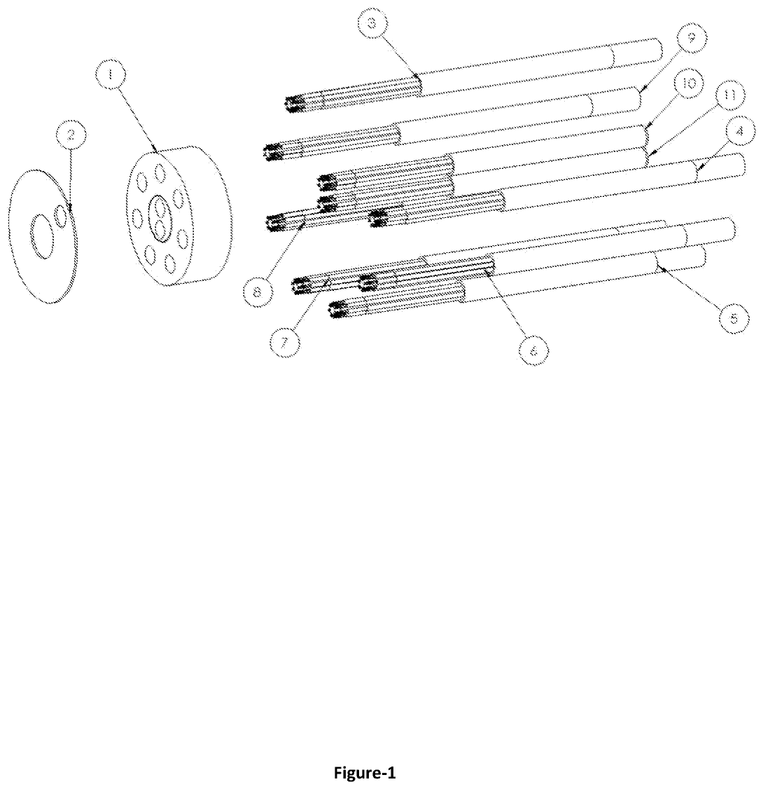

FIG. 2 is the drawing that illustrates the view of the reflection modules in the system according to the present invention.

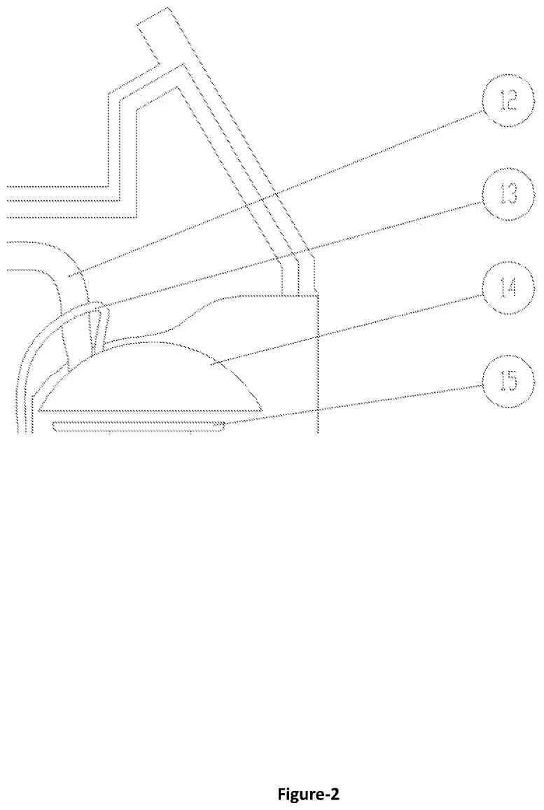

FIG. 3 is the drawing that illustrates the view of the transmission modules in the system according to the present invention.

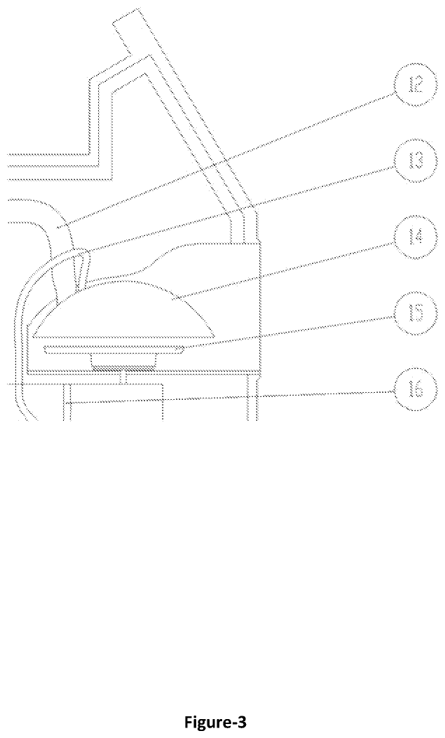

FIG. 4 is the drawing that illustrates the view of the sampling part in the system according to the present invention.

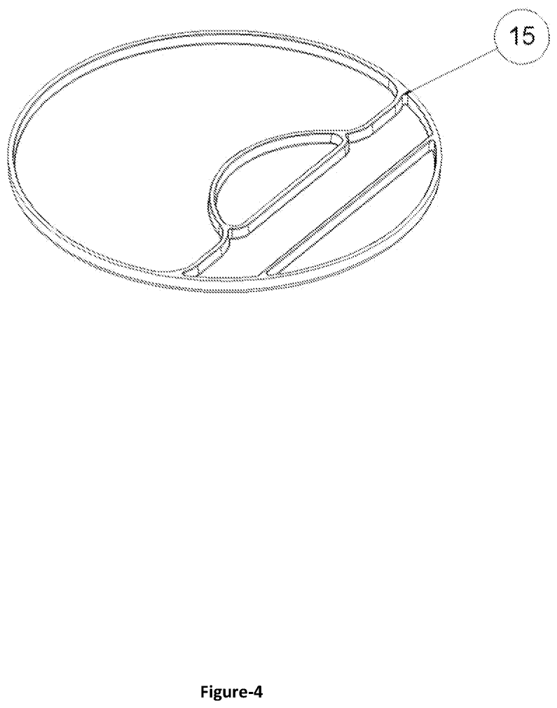

FIG. 5 is the drawing that illustrates the view of the detection part in the system according to the present invention.

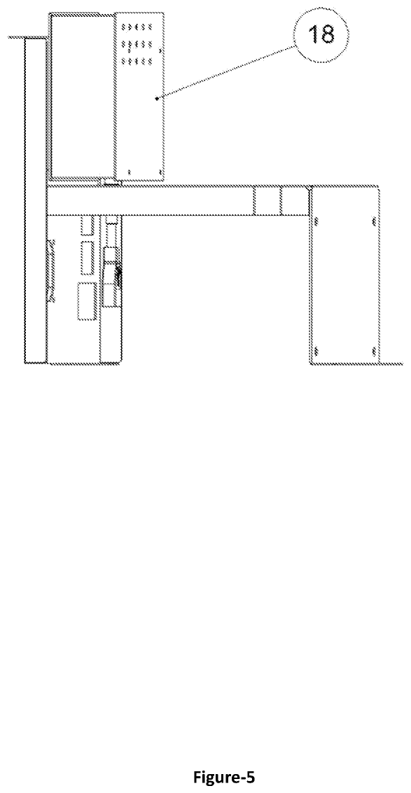

FIG. 6 is the drawing that illustrates the view of the of the interface part in the system according to the present invention.

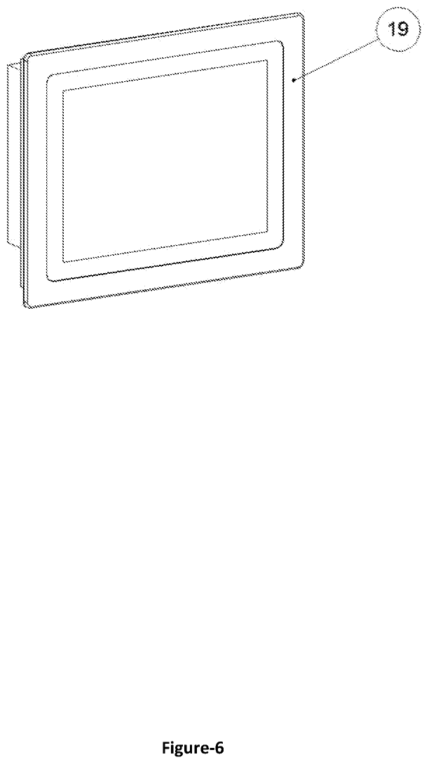

FIG. 7 is the drawing that illustrates the view of the measurement system in the system according to the present invention.

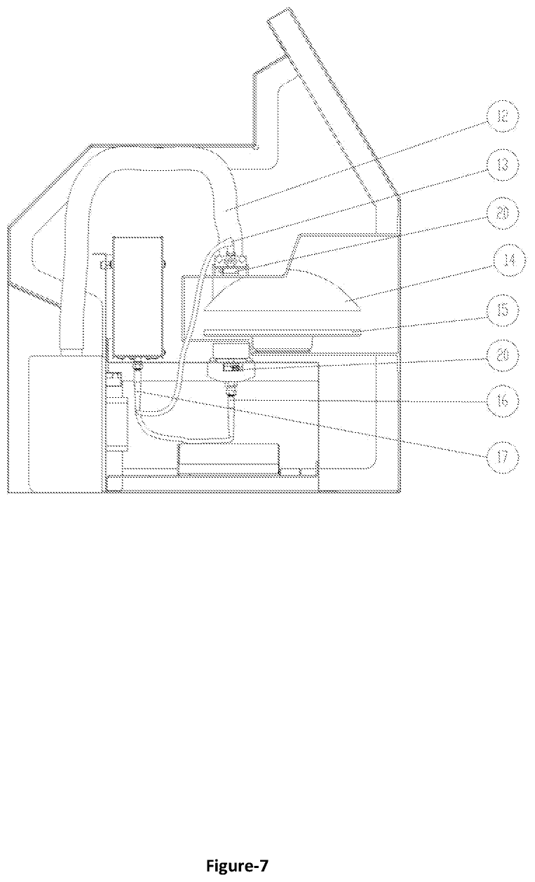

### DESCRIPTION OF ELEMENTS/PARTS OF THE INVENTION

Parts shown in the figures are enumerated and numbers corresponding the respective parts are provided below in order to provide a better understanding for the measuring system comprising the Device for Measuring Element and Molecular Properties with Hybrid Electromagnetic Waves in the present invention.
1. Multiple optical head
2. Beam mixing disc
3. X-ray fiber and its connector
4. Gamma-ray fiber and its connector
5. Ultraviolet-ray fiber and its connector
6. Visible-light fiber and its connector
7. Near infrared ray fiber and its connector
8. Mid-infrared ray fiber and its connector
9. Far-infrared ray fiber and its connector
10. Microwave transmitter and its connector
11. Radio Wave transmitter and its connector
12. Receiving beam fiber cable
13. Reflected beam fiber cable
14. Hemispherical reflection collector
15. Sampling disc
16. Transmitted beam fiber cable
17. Y fiber spectrometer input cable
18. Detection module
19. User interface module
20. Optical shutter

### DETAILED DESCRIPTION OF THE INVENTION

The present invention relates to an intelligent measuring system which is composed by integrating X-Rays, Gamma-Rays, ultraviolet rays, Visible light, near-mid-far infrared rays, and reflection and transmission methods with fiber cables, optical systems, and optical sensors to microwave and radio waves by using artificial intelligence and statistical methods. The present invention particularly comprises a hybrid optical measurement system that can be used in various areas to determine moisture, protein, fat, carbohydrate, molecule and element properties.

Optical systems, artificial intelligence and statistics-based data processing, and analysis and management system will be formed, in which the information obtained from the samples measured by the hybridized optical system is used, by means of the present invention. The beams specified in the system come from 9 different sources. Beams from these 9 separate sources are sent onto the sample by integrating optical signals in combinations of two, three, four, five, six, seven, eight, and nine. The beams reflected from the sample and passed through the sample pass from the reflection and transmission modules, respectively to the detection module. In the detection module, the beam is converted into an electrical signal. Then the signal converted to electrical signal is converted to digital. After the spectral signal processing module, the data is stored in the data cloud and the desired molecule/element is defined and determined by using artificial intelligence and statistical methods.

Said system comprises multiple optical head (1), in which beams from electromagnetic sources (X-ray, Gamma ray, Ultraviolet rays, visible region light, Near-mid-far infrared rays, Microwave and Radio waves) of beam-waves in the electromagnetic spectrum are combined with multi-fiber cables; beam mixing disc (2), which will enable the integrating electromagnetic beam-waves according to the determined characteristics; fiber and its connector (3) providing transmission of the X-ray; fiber and its connector (4) providing gamma-ray transmission; fiber and its connector (5) providing transmission of the ultraviolet rays; fiber and its connector (6) providing transmission of visible beam/light; fiber and its connector (7) for transmitting near-infrared-rays; fiber and its connector (8) for transmitting the mid-infrared-rays; fiber and its connector (9) for transmitting far-infrared-rays; fiber and its connector (10) for transmitting the microwave-beam; fiber/cable and its connector (11) providing transmission of the radio wave beam; receiving beam fiber/cable (12); reflected beam fiber cable (13); hemispherical reflection beam collector (14), which collects the reflected rays; sampling disc (15) on which the samples to be measured are placed; transmitted beam fiber cable (16) that allows the beams transmitted from samples to be received from optical systems, Y fiber spectrometer input cable (17), which provides reflection and transmission of transmitted beams to the spectrometer; detection module (18) that enables detecting optical beams in the system, converting the rays into electrical signals and digitizing them, personal user interface (19); and shutter (20).

The multi-optical head (1) is made of anodized black aluminum material. The head part is specially slotted for connecting optical cables. It is used for the connection of 9 separate fiber cables.

The beam mixing disc (2) is made in different shapes and forms. It is formed by anodized black aluminum material. The beams from 9 individual fiber cables are mechanically developed to form combinations of two, three, four, five, six, seven, eight and nine.

X-ray fiber and its connector (3) consist of a fiber cable and connection apparatus capable of transmitting beams between 1 pm and 1 nm wavelengths. Fiber cable is made as multimode. The connection apparatus is most conveniently used for fiber cables to transmit the beam to the opposite side.

Gamma-ray fiber and its connector (4) consist of a fiber cable and connection apparatus capable of transmitting beams with wavelengths less than 10 pm. Fiber cable is made as multimode. The connection apparatus is most conveniently used for fiber cables to transmit the beam to the opposite side.

The ultraviolet light fiber and its connector (5) consist of a fiber cable and connection apparatus capable of transmitting beams between 1 nm and 400 nm wavelengths. Fiber cable is made as multimode. The connection apparatus is most conveniently used for fiber cables to transmit the beam to the opposite side.

Visible-light fiber and its connector (6) consist of a fiber cable and connection apparatus capable of transmitting beams between 400 nm and 750 nm wavelengths. Fiber cable is made as multimode. The connection apparatus is most conveniently used for fiber cables to transmit the beam to the opposite side.

The near infrared light fiber and its connector (7) consist of a fiber cable and connection apparatus capable of transmitting beams between 750 nm and 2.5 μm wavelengths. Fiber cable is made as multimode. The connection apparatus is most conveniently used for fiber cables to transmit the beam to the opposite side.

The mid-infrared light fiber and its connector (8) consist of a fiber cable and connection apparatus capable of transmitting beams between 2.5 μm and 8 μm wavelengths. Fiber cable is made as multimode. The connection apparatus is most conveniently used for fiber cables to transmit the beam to the opposite side.

The far infrared light fiber and its connector (9) consist of a fiber cable and connection apparatus capable of transmitting rays between 8 μm and 25 μm wavelengths. Fiber cable is made as multimode. The connection apparatus is most conveniently used for fiber cables to transmit the beam to the opposite side.

The microwave-beam fiber and its connector (10) consist of a fiber cable and connection apparatus capable of transmitting rays between 25 μm and 1 mm wavelengths. Fiber cable is made as multimode. The connection apparatus is most conveniently used for fiber cables to transmit the beam to the opposite side.

Radio wave beam fiber and its connector (11) consist of a fiber cable and connection apparatus capable of transmitting beams greater than 1 mm in wavelength. Fiber cable is made as multimode. The connection apparatus is most conveniently used for fiber cables to transmit the beam to the opposite side.

The receiving beam fiber cable (12) has been developed as a multi-fiber combination and as multimode to transmit rays at all wavelengths.

Reflected beam fiber cable (13) has been developed as a multi-fiber combination and as multimode, which is utilized to transmit beams at all wavelengths. This will allow beams to be received from the hemispherical reflection collector.

The hemispherical reflection collector (14) will be placed with materials such as gold, magnesium oxide, barium sulfate, aluminum, and PTFE by homogeneous scattering and deposition method.

The sampling disc (15) is made of polymer etc. material. They are mainly made of polycarbonate, glass, quartz, and sapphire materials.

The transmitted beam fiber cable (16) has been developed as a multi-fiber combination and as multimode, which is used to transmit beams of all wavelengths. It will ensure that the beams transmitted from the sampling disk and the samples are received.

Y fiber spectrometer input cable (17) has been developed as a 2:1 (Y-shaped), multi-fiber combination and as multimode, which transmits the beams from the fiber cables that collect reflection and transmitted beams to the spectrometer.

The detection module (18) is an optoelectronic system capable of sensing at all wavelengths used in the system to detect optical beams, convert the beams into electrical signals, and digitize them.

The user interface (19) consists of a touch screen and a computer that provides information display and data entry.

The shutter (20) is the curtain that optically controls the passage of the beam.

The working principle of the present invention comprises the following process steps.
The system works in two different modes. In the first mode, the sample is scanned and the molecules and elements in the sample are identified, and the qualitative and quantitative measurement values of the molecules and elements identified are determined. In the other mode, the beam modulation is determined according to the chemical structure of the molecule (Water, oil, protein, etc.) to be scanned, and the sample is scanned in different combinations, as a result of scanning, the amount of molecule/element is determined qualitatively and quantitatively.
transmitting the beams by means of using Rays from light sources X-ray fiber and its connector (3), Gamma-ray fiber and its connector (4), ultraviolet-light fiber and its connector (5), Visible-light fiber and its connector (6), near infrared light fiber and its connector (7), mid-infrared light fiber and its connector (8), far-infrared light fiber and its connector (9), microwave-beam fiber and its connector (10), and radio wave beam fiber and its connector (11)
Modulating the transmitted beams with different beam superimposition/interaction techniques on the beam mixing disc (2) by using multiple optical heads (1),
Directing the modulated beam onto the sample by using the receiving beam fiber cable (12),
Transmitting the reflected beams from the fiber cable (13) to the Y spectrometer input cable (17) by the hemispherical reflection collector (14) that firstly collects the beams reflected from the material on the sampling disc (15) in reflection mode in this innovative system that uses reflection and transmission modes simultaneously,
Transmitting the beams passing through the sampling disc (15) to the Y spectrometer input cable (17) with the transmitted beam cable (16) in the transmission mode,
Converting and digitizing the beams received from Y spectrometer input cable (17) into electrical signals of different wavelengths with the spectrometers in the detection module (18),
Displaying data/information obtained through the user interface (19) and entering user information,
Controlling the passage of beams obtained by reflection or transmission by the shutter (20).

1. An opto-electronic measurement system for the qualitative and quantitative determination of molecules and elements comprising device for measuring element and molecular properties with hybrid electromagnetic qaves, characterized by comprising;
Multiple optical head (1) that allows the beams to be collected and transmitted in the same direction,
Beam mixing disc (2), developed for making the modulations and superimpositioning/interacting the beams,
X-ray fiber and its connector (3) that enables the transmission of the beams coming from the X-ray source,
Gamma-ray fiber and its connector (4) that enables the transmission of the beams coming from the gamma ray source,
Ultraviolet light fiber and its connector (5) that provides the transmission of the beams coming from the ultraviolet light source,
Visible-light fiber and its connector (6) that enables the transmission of the beams coming from the visible light source,
Near-infrared-light fiber and its connector (7) that enables the transmission of the beams coming from the near-infrared light source,
Mid-infrared-light fiber and its connector (8) that enables the transmission of beams coming from the mid-infrared light source,
Far-infrared-light fiber and its connector (9) that enables the transmission of beams from the far-infrared light source,
Microwave-transmitter and its connector (10) that enables the transmission of the waves coming from the microwave generating source,
Radio wave-transmitter and its connector (11) that enables the transmission of the waves coming from the radio wave generating source,
Receiving beam fiber cable (12) ensuring that beams of all wavelengths are directed on the sample,
Reflected beam fiber cable and its connector (13) ensuring that the reflected beams of all wavelengths are received from within the hemisphere,
Hemispherical reflection collector (14) that collects the beams reflected from the sample,
Sampling disc (15), on which the material/materials that are planned to be measured are placed,
Transmitted beam fiber cable and its connector (16) that provides the transmission of beams passing through the sampling disc and the substance/material thereon,
Y spectrometer input cable (17) ensuring that the reflected and transmitted beams are transmitted to the detection module synchronously,
Detection module (18) that allows the beams to be separated according to their wavelengths, converts the beams into electrical signals and converts the electrical signal into digital, and
Computerized user interface system (19) for displaying acquired data/information and entering user information.

2. A system for measuring molecular properties with hybrid electromagnetic waves according to claim 1, characterized by comprising; multiple optical head (1) that allows for combining a wide range of beams produced at different wavelengths in a single interface.

3. A system for measuring molecular properties with hybrid electromagnetic waves according to claim 2, characterized by comprising; multiple optical head (1) made of anodized black aluminum material.

4. A system for measuring molecular properties with hybrid electromagnetic waves according to claim 1, characterized by comprising; beam mixing disc (2) made of anodized black aluminum material.

5. A system for measuring molecular properties with hybrid electromagnetic waves according to claim 1, characterized by comprising; an opto-mechanical beam mixing disc (2).

6. A system for measuring molecular properties with hybrid electromagnetic waves according to claim 1, characterized by comprising; the beam mixing disc (2) that allows beams to be superimposed in different combinations.

7. A system for measuring molecular properties with hybrid electromagnetic waves according to claim 1, characterized by comprising; the beam mixing disc (2) that allows for modulating beams in different combinations with each other.

8. A system for measuring molecular properties with hybrid electromagnetic waves according to claim 1, characterized by comprising: sampling disc (15) made of polycarbonate, sapphire, and quartz materials.

9. A system for measuring molecular properties with hybrid electromagnetic waves according to claim 1, characterized by comprising a system capable of detecting in both reflection and transmission mode.

10. A system for measuring molecular properties with hybrid electromagnetic waves according to claim 1, characterized by comprising: hemispherical reflection collector (14) used to collect the beams reflected from substances and materials.

11. A system for measuring molecular properties with hybrid electromagnetic waves according to claim 1, characterized by comprising; intelligent optical transmission system that enables the beams collected from the reflected beam fiber cable (13) and the transmitted beam fiber cable (16) to be transmitted to the detection module with the desired synchronization via the Y spectrometer input fiber cable (17).

12. A system for measuring molecular properties with hybrid electromagnetic waves according to claim 1, characterized by comprising; a user interface (19) with display program feature.

13. The working method of the system for measuring molecular properties with hybrid electromagnetic waves, characterized by comprising the process steps of;
Modulating and superimpositioning/interacting the beams taken from the beam sources in the beam mixer (2), directing it on the substance/materials on the sampling disc (15), collecting the reflected beams in the hemispherical collector (14), combining the reflected beams with the reflection fiber cable (13) and the transmitted beam fiber cable in the Y spectrometer input fiber and transmitting them synchronously,
Transmitting the vibration beams of the material/substance molecules and elements planned to be determined to the beam mixer (2),
Directing the beams formed in different combinations to the materials and substances on the sampling disc (15),
Separating the beams obtained in the detection module (18) into frequencies/wavelengths,
Transforming the beams separated into different wavelengths into electrical signals in the detection module (18),
Converting beam information converted into electrical signals in the detection module (18) into digital,
Converting accumulated data into molecular/element qualitative and quantitative data with the computerized user interface (19).

14. The working method of the system for measuring molecular properties with hybrid electromagnetic waves, characterized in that; it can work in the temperature range of (−20°)-(+60°).

15. The use of the data obtained in claim 13 with artificial-intelligence (ANN-CNN-Machine learning and Deep learning techniques) and Statistical methods.
